(19) United States
(12) Patent Application Publication
(10) Pub. No.: US 2009/0070491 A1
(43) Pub. Date: Mar. 12, 2009

(54) Method for executing target programs with compound quick keys

(76) Inventor: Chai-Chang Chiu, Tucheng City (TW)

Correspondence Address: QUINTERO LAW OFFICE, PC, 2210 MAIN STREET, SUITE 200, SANTA MONICA, CA, 90405, US

(21) Appl. No.: 11/898,083

(22) Filed: Sep. 10, 2007

(51) Int. Cl. G06F 3/02

(52) U.S. Cl. 710/5

(57) ABSTRACT

Disclosed is a method for executing target programs with compound quick keys, which is applicable to a computer that is pre-loaded with a compound quick-key program matching list that contains data of at least one function key, at least one single-key quick key, and an event signal and a target program associated with the quick key. After the computer loads the operating system, a compound quick-key management program is activated to read the compound quick-key program matching list. When a user actuates the function key and the single-key quick key simultaneously, the keyboard controller transmits the event signal associated with the actuated function key and the single-key quick key and executes the target program associated with the actuated function key and the single-key quick key in accordance with compound quick-key program matching list.

### FIELD OF THE INVENTION

The present invention generally relates to the execution of a program with a quick key, and in particular to a method for efficiently executing a preset target program associated with a quick key when the quick key and a function key of a keyboard are simultaneously actuated.

### BACKGROUND OF THE INVENTION

Keyboards are known to be used as an important input device for computer systems, and symbols, such as digits, characters and command instructions and other data are entered to a computer system through the keyboard. Regular desktop computers use an independent keyboard module, which is connected to the computer through a connection wire and a connector. Wireless technologies are also broadly used in keyboard-computer connections.

In the design of notebook computers, most of the notebook computers are provided with a keyboard that is embedded in a casing of the notebook computer to allow a user to enter digits, characters and command instructions to the notebook computer.

In a conventional notebook computer, the user is allowed to set up hot keys, such as Fn+F1 or Fn+direction arrows, of the notebook computer to match up with desired control functions, such as volume control, power management, or wireless communication. Quick keys are also found in certain designs of the computers. The quick keys are also used to control similar computer functions.

In order to perform the highest efficiency of the function keys and the quick keys, computer manufacturers develop several types of model. Conventionally, the function key Fn is combined with preset specific keys of the keyboard to control functions such as wireless internet connection, volume control or silence mode, screen brightness adjustment, screen switching, sleep mode control, and screen output settings. The quick keys (switches designed to work with the GPIO of the keyboard controller) are set to control functions such as disc ejection of optic disk drive.

Various related technologies can be found in the prior references. For example, U.S. Pat. No. 6,574,517 discloses a multi-function key processing method for a keyboard device, wherein multi-key code technology is employed to carry out identification and processing of key actuation. The method uses a keyboard controller to scan and detect the key actuated by the user, and if the key is determined to be a multi-function key, then three key codes are generated. The first key code is the scan code of the windows key; the second one is the code of “Ctrl”, “Alt”, “Shift”; the third one is the key code of the actuated key. The multi-function key code made up by the three key codes is transmitted to the computer or the keyboard controller for key identification.

### SUMMARY OF THE INVENTION

Although the conventional techniques are effective in realizing certain degree of simplification, quick execution of preset programs and other specific functions, there are still drawbacks. For example, in the multi-function code technology mentioned previously, the actuation of the multi-function key of the keyboard must be detected before three different key codes are generated. This makes scanning and processing the keys troublesome and consumes more system resources.

Further, in setting up a function or program, if one of the function keys or quick keys is specifically designated as a user hot key for executing, for example, Microsoft® Outlook Express or a browser or other related application programs, then the number of function keys and quick keys on the keyboard decreases. Thus, this is barely a conversion or switching of the function of the keys, and does not solve the issue of limited availability of function keys and quick keys.

Thus, an objective of the present invention is to provide a method for executing target programs with compound quick keys, which uses a compound quick-key program matching list and a compound quick-key management program to allow users to set up hot keys for fast program execution.

Another objective of the present invention is to provide a method for executing target programs with compound quick keys, whereby by using the technology presented here, a compound quick key can quickly start a preset program, and users are allowed to use the present invention under any application software, which provides user with convenient and efficient assistance in operating application software of computer.

A further objective of the present invention is to provide a compound quick key identifying and processing method, whereby when the keyboard controller detects that the function key and a single-key quick key are actuated simultaneously, an event signal associated with the actuated function key and the quick key is transmitted to the computer.

The present invention solves the conventional drawbacks by implementing a compound quick-key program matching list that contains data of at least one function key, at least one single-key quick key, and an event signal and a target program associated with the quick key. After the computer loads the operating system, a compound quick-key management program is activated to read data from the compound quick-key program matching list. When a user actuates the function key and the single-key quick key simultaneously, the keyboard controller transmits the event signal associated with the actuated function key and the single-key quick key and executes the target program associated with the actuated function key and the single-key quick key in accordance with the compound quick-key program matching list.

As compared to the known technologies, the present invention effectively uses the conventional keyboard hot keys to fast execute target programs. The present invention uses the method of executing target programs with compound quick keys to overcome the drawbacks of using a keyboard to input command lines and activate the corresponding program. Further, the present invention allows users to set up quick keys and the matching target programs. The compound quick-key management program, the compound quick-key program matching list, and the single-key quick-key program matching list can all be designed according to the user, making it more convenient.

The advantages of the present invention include:

(1) It expands the functions of a keyboard without adding extra hardware or keys;

(2) Users can define new program executing key by using the original function key Fn and hot keys. The hot keys and the function keys can be used together as new program executing keys; and

(3) Users can press the function key and the hot key at the same time to set up software, and it is easy to set up the corresponding target program.

### BRIEF DESCRIPTION OF THE DRAWINGS

The present invention will be apparent to those skilled in the art by reading the following description of the best mode for carrying out the present invention, with reference to the attached drawings, in which:

FIG. 1 shows a block diagram of a computer system in which a method for executing target programs with compound quick keys is embodied;

FIG. 2 is a perspective view showing a notebook computer on which a plurality of single-key quick keys and a function key are arranged;

FIG. 3 is a plan view illustrating a notebook computer on which a plurality of regular keys, a plurality of single-key quick keys and a function key are arranged;

FIG. 4 shows an example of a compound quick-key program matching list shown in FIG. 1;

FIG. 5 shows an example of a single-key quick-key program matching list shown in FIG. 1; and

FIG. 6 is a flow chart of the method in accordance with the present invention.

### DETAILED DESCRIPTION OF THE PREFERRED EMBODIMENTS

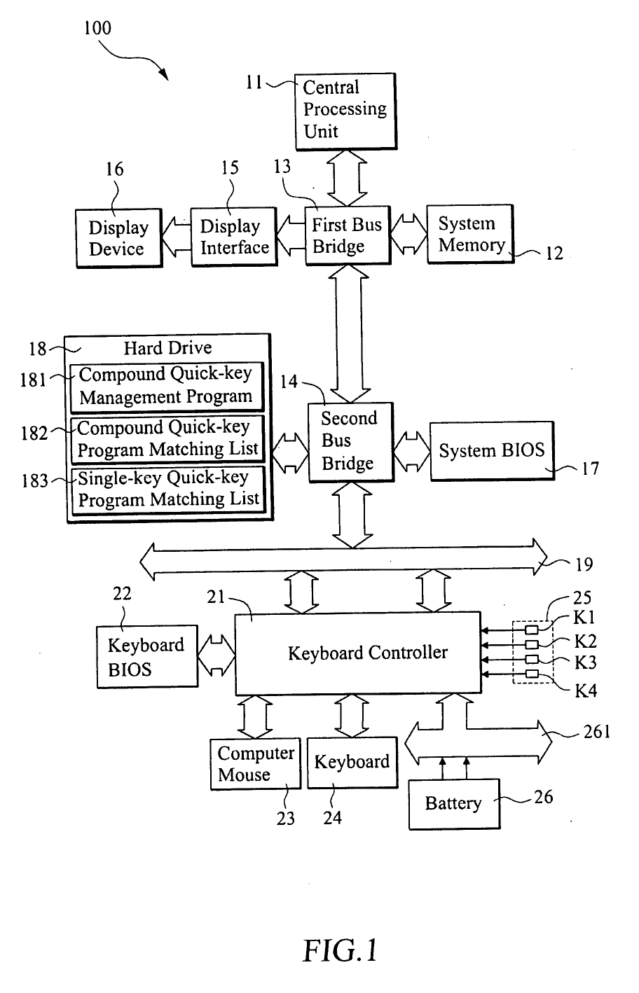

With reference to the drawings and in particular to FIG. 1, which shows a block diagram of a computer system in which a method for executing target programs with compound quick keys is embodied, the computer system, generally designated with reference numeral 100, comprises a central processing unit 11, a system memory 12, a first bus bridge 13, a second bus bridge 14, a display interface 15, a display device 16, a system basic input/output system (system BIOS) 17, and a hard drive 18.

The first bus bridge 13 (also known as the “north bridge”) is connected to the display device 16 through the display interface 15. The second bus bridge 14 (also known as the “south bridge”) is connected to the system BIOS 17 and the hard drive 18. The hard drive 18 contains a compound quick-key management program 181, a compound quick-key program matching list 182, and a single-key quick-key program matching list 183.

A keyboard controller 21 is connected to the second bus bridge 14 through a bus 19. The keyboard controller 21 is connected to a keyboard basic input/output system (keyboard BIOS) 22, a computer mouse 23, a keyboard 24, and a set of quick keys 25. The quick key set 25 includes a plurality of single-key quick keys K1, K2, K3, K4. The keyboard 24 is made of a plurality of single keys arranged in a matrix, and each key represents a certain character. When a key is pressed, the keyboard controller 21 can detect the key status by the conventional code scanning technology.

If the computer system 100 is a notebook computer, the source of power supply will be a battery 26 (such as the smart battery broadly used today). The battery 26 is connected to the keyboard controller 21 through a SM bus 261.

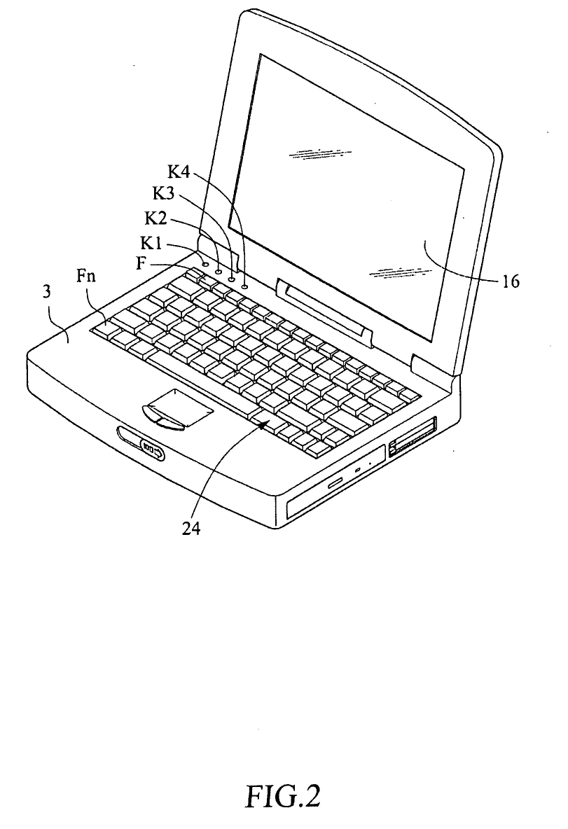

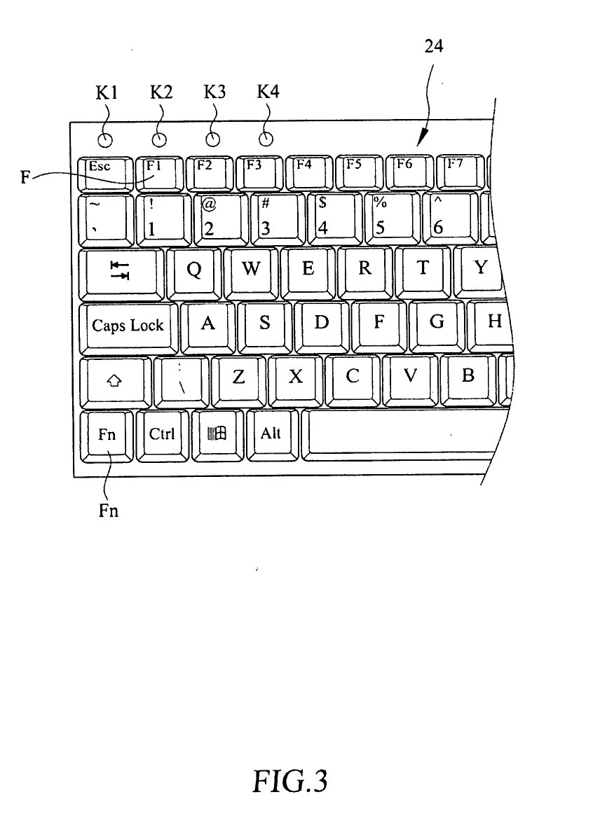

FIG. 2 is a perspective view showing a notebook computer on which a plurality of single-key quick keys K1, K2, K3, K4 and a function key Fn are arranged; and FIG. 3 is a plan view illustrating a notebook computer on which a plurality of single-key quick keys K1, K2, K3, K4 and a function key Fn are arranged. The notebook computer comprises a casing 3 on which a keyboard 24 that consists of a plurality of keys is provided. One of the keys that constitute the keyboard 24 is a function key Fn. The keyboard 24 also includes a plurality of function keys F each having a specific function, such as F1, F2, F3 and the likes that are currently adopted in a standard keyboard. Each function key F is associated with a function that is pre-defined by the computer system or is a user-defined function.

The single-key quick keys K1, K2, K3, K4 are located at pre-set positions on the casing 3. Each single-key quick key K1, K2, K3, K4 matches a default (system-defined) or user-defined program. When any of the single-key quick keys K1, K2, K3, K4 is pressed, the pre-set corresponding program, which is recorded in the single-key quick-key program matching list 183 and associated with the pressed key, will start to execute.

The connection framework and key identification of the function key and the single-key quick keys with respect to the keyboard controller 21 are different. The function key Fn and each regular key of the keyboard 24 are connected to the keyboard controller 21, and upon actuation, the key sends out a scan code thereof to the keyboard controller 21. The single-key quick keys K1, K2, K3, K4 are directly connected to the keyboard controller 21, and upon actuation, directly generate and send out a key signal of the actuated quick key to the keyboard controller 21.

The compound quick-key program matching list 182 contains the function key, at least one single-key quick key, and an event signals and a target program corresponding to a compound quick key associated with the single-key quick key. When the compound quick-key management program 181 is activated, the data stored in the compound quick-key program matching list 182 are read. These data might be a default setting of the system or designed and established personally by the user.

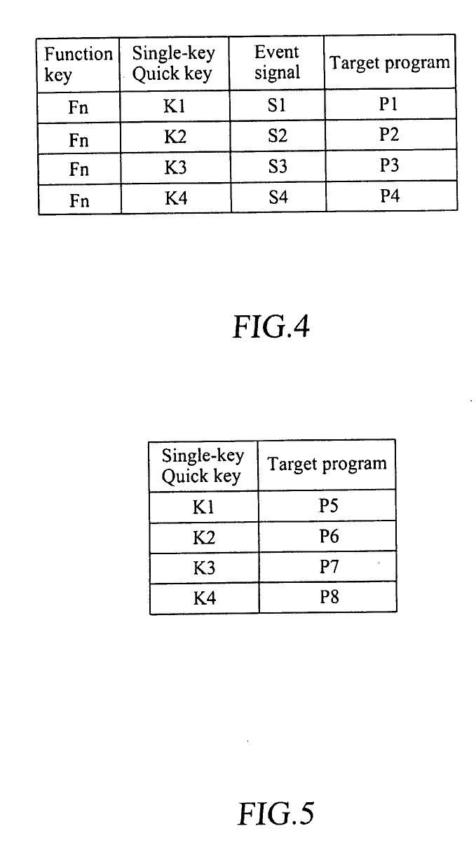

FIG. 4 shows an example of the compound quick-key program matching list 182 shown in FIG. 1. In the example, the compound quick-key program matching list 182 records the data of four compound quick keys and preset target programs respectively associated therewith, which include:

a first set of data including a compound quick key Fn+K1, an event signal S1, and a preset target program P1;

a second set of data including a compound quick key Fn+K2, an event signal S2, and a preset target program P2;

a third set of data including a compound quick key Fn+K3, an event signal S3, and a preset program P3;

a fourth set of data including a compound quick key Fn+K4, an event signal S4, and a default program P4.

The single-key quick-key program matching list 183 contains at least one single-function quick key and a preset target program associated therewith. When the compound quick-key management program 181 is activated, the data stored in the single-key quick-key program matching list 183 are accessed. These data might be a default value of the system or designed and established personally by the user.

FIG. 5 shows an example of the single-key quick-key program matching list 183 shown in FIG. 1. In the example, the single-key quick-key program matching list 183 records four sets of data indicating correspondence between the single-key quick keys and the target programs, which data are:

a first set of data including a single-key quick key K1 and a corresponding preset target program P5;

a second set of data including a single-key quick key K2 and a corresponding preset target program P6;

a third set of data including a single-key quick key K3 and a corresponding preset target program P7;

a fourth set of data including a single-key quick key K4 and a corresponding present target program P8.

The data contained in the compound quick-key program matching list 182 and the single-key quick-key program matching list 183 might be system default values or are alternatively established by the user and loaded into the hard drive 18. The data can also be stored in other memories, for example a memory of keyboard controller 21, or is directly built in the keyboard BIOS 22.

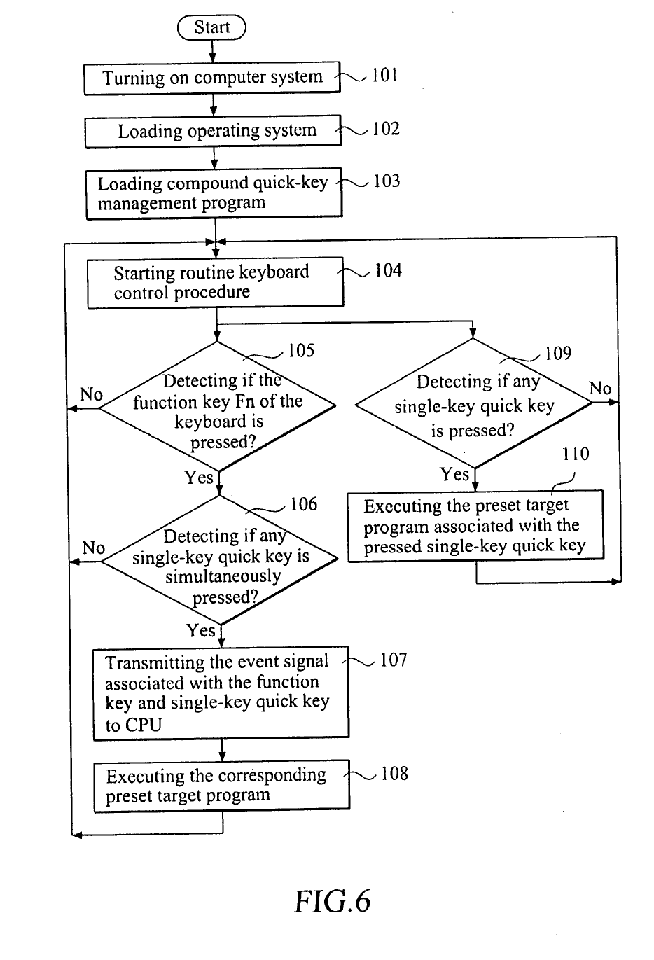

FIG. 6 is a flow chart of the method in accordance with the present invention. The method will be further described, also with reference to the previous drawings. When the computer system 100 is turned on (step 101), and loading of the operating system is completed (step 102), the central processing unit 11 loads the compound quick-key management program 181 from the hard drive 18 (step 103), and loads the compound quick-key management program 181 in the system memory 12 of the computer system 100. The keyboard controller 21 then starts the routine keyboard control procedure (step 104), such as battery detection, keyboard detection, switch status detection and the likes.

When the keyboard controller 21 detects that the user presses down the function key Fn of the keyboard 24 (step 105), the keyboard controller 21 immediately checks whether the user simultaneously presses down any of the single-key quick keys K1, K2, K3, K4 (step 106). If so, the keyboard controller 21 transmits the event signal (s1, s2, s3, s4) associated with the combination of function key Fn and the pressed single-key quick key (K1, K2, K3, K4) to the central processing unit 11 (step 107), and the central processing unit 11 will execute the corresponding preset target program associated with the function key Fn and the pressed single-key quick key (K1, K2, K3, K4) in accordance with the compound quick-key program matching list (step 108).

When the user only presses down or actuates one of the single-key quick keys (K1, K2, K3, K4), the keyboard controller 21 detects the actuation of the single-key quick key (K1, K2, K3, K4) (step 109). Then the keyboard controller 21 executes the preset target program associated with the pressed single-key quick key (K1, K2, K3, K4) according to the single-key quick-key program matching list 183 (step 110).

With the combination of the function key Fn and any of the single-key quick keys (K1, K2, K3, K4), the present target program associated with the pressed single-key quick key K1, K2, K3, K4 according to the matching list 183 can be readily executed. This allows a user to use the quick keys as quick start keys for executing specific software.

With the above description, it is understood that in accordance with the present invention, by using the function key of the conventional keyboard, together with the single-key quick keys and the compound quick-key management program, a user can easily set the Fn plus quick key to execute corresponding program (for example opening Microsoft® Outlook or a browser). This provides convenience for the user.

Although the present invention has been described with reference to the best mode for carrying out the invention, it is apparent to those skilled in the art that a variety of modifications and changes may be made without departing from the scope of the present invention which is intended to be defined by the appended claims.

What is claimed is:

1. A method for executing target programs with compound quick keys, which is applicable to a computer system including a central processing unit, a system basic input/output system (system BIOS), a hard drive, a keyboard controller, and a keyboard, wherein the keyboard includes at least one function key, at least one single-key quick key, and a plurality of regular keys, the function key and the regular keys being connected to the keyboard controller and, upon actuation, generating a scan code associated with the actuated regular key to the keyboard controller, the single-key quick key being directly linked to the keyboard controller and, upon actuation, generating a key signal to the keyboard controller, the method comprising the following steps:
(a) activating a compound quick-key management program after the computer system loads an operating system, the compound quick-key management program functioning to read data contained in a compound quick-key program matching list that contains the function key, the single-key quick key, an event signal, and an associated target program;
(b) using the keyboard controller to detect whether the function key and the single-key quick key are simultaneously actuated;
(c) the keyboard controller transmitting the event signal associated with the actuated single-key quick key and the function key to the central processing unit; and
(d) starting to execute the target program associated with the actuated function key and the single-key quick key in accordance with the data contained in the compound quick-key program matching list.

2. The method as claimed in claim 1, wherein the compound quick-key management program, the compound quick-key program matching list, and a single-key quick-key program matching list are previously installed in the hard drive of the computer system.

3. The method as claimed in claim 1, wherein the hard drive of the computer system contains a single-key quick-key program matching list, which contains data of the single-key quick key and a target program associated with the quick key.

4. The method as claimed in claim 3, wherein when the keyboard controller detects that the single-key quick key is actuated, the keyboard controller starts to execute the target program associated with the actuated quick key in accordance with the single-key quick-key program matching list.

5. The method as claimed in claim 1, wherein the computer system comprises a notebook computer.

6. A method for executing target programs with compound quick keys, which is applicable to a computer system including a central processing unit, a system basic input/output system (system BIOS), a hard drive, a keyboard controller, and a keyboard, wherein the keyboard includes at least one function key, at least one single-key quick key, and a plurality of regular keys, the function key and the regular keys being connected to the keyboard controller and, upon actuation, generating a scan code associated with the actuated regular key to the keyboard controller, the single-key quick key being directly linked to the keyboard controller and, upon actuation, generating a key signal to the keyboard controller, the computer system being pre-loaded with a compound quick-key program matching list that contains data of the function key, the single-key quick key, an event signal, and an associated target program, the method comprising the following steps:
(a) using the keyboard controller to detect whether the function key and the single-key quick key are simultaneously actuated;
(b) the keyboard controller transmitting the event signal associated with the actuated single-key quick key and the function key; and
(c) starting to execute the target program associated with the actuated function key and the single-key quick key in accordance with the data contained in the compound quick-key program matching list.

7. The method as claimed in claim 6, wherein the compound quick-key program matching list is previously installed in the hard drive of the computer system.

8. The method as claimed in claim 6, wherein the hard drive of the computer system contains a single-key quick-key program matching list, which contains data of the single-key quick key and a target program associated with the quick key.

9. The method as claimed in claim 8, wherein when the keyboard controller detects that the single-key quick key is actuated, the keyboard controller starts to execute the target program associated with the actuated quick key in accordance with the single-key quick-key program matching list.

10. The method as claimed in claim 6, wherein the computer system comprises a notebook computer.

11. A method for executing target programs with compound quick keys, which is applicable to a computer system including a keyboard, in which at least one function key, at least one single-key quick key, and a plurality of regular keys are arranged, wherein the function key and the regular keys are connected to the keyboard controller and, upon actuation, generate a scan code associated with the actuated regular key to the keyboard controller, and the single-key quick key is directly linked to the keyboard controller and, upon actuation, generates a key signal to the keyboard controller, the method comprising the following steps:
(a) establishing a compound quick-key program matching list that contains data of the function key, the single-key quick key, and an associated event signal;
(b) using the keyboard controller to detect whether the function key and the single-key quick key are simultaneously actuated; and
(c) the keyboard controller transmitting the event signal associated with the actuated single-key quick key and the function key to the central processing unit.

12. The method as claimed in claim 11, wherein the compound quick-key program matching list is previously installed in the hard drive of the computer system.

13. The method as claimed in claim 11, wherein step (a) further comprises establishing a single-key quick-key program matching list, whereby when the keyboard controller detects that the single-key quick key is actuated, the keyboard controller starts to execute a target program associated with the actuated single-key quick key in accordance with the single-key quick-key program matching list.

14. The method as claimed in claim 11, wherein the computer system comprises a notebook computer.
